(19) United States
(12) Patent Application Publication
(10) Pub. No.: US 2025/0278186 A1
(43) Pub. Date: Sep. 4, 2025

(54) BAD-DECK MANAGEMENT FOR HALF-GOOD BLOCKS

(71) Applicant: Micron Technology, Inc., Boise, ID (US)

(72) Inventor: Meng Wei, Shanghai (CN)

(21) Appl. No.: 19/047,110

(22) Filed: Feb. 6, 2025

Related U.S. Application Data
(60) Provisional application No. 63/561,194, filed on Mar. 4, 2024.

(51) Int. Cl. G06F 3/06

(52) U.S. Cl. CPC G06F 3/0608; G06F 3/064; G06F 3/0653; G06F 3/0679

(57) ABSTRACT

A system includes a memory device and a processing device operatively coupled to the memory device. The processing device is to perform operations including setting a partial translation unit (TU) pointer to identify a first partial-TU of an ordered sequence of partial-TUs, the ordered sequence spanning over a plurality of dies of the memory device. The operations further include, responsive to determining that the first partial-TU has a good health status, appending the first partial-TU to a partial-TU stripe and incrementing the partial-TU pointer to identify a second partial-TU. The operations further include, responsive to determining that the second partial-TU has a bad health status, incrementing the partial-TU pointer without adding the second partial-TU to the partial-TU stripe. The operations further include performing one or more write operations on a plurality of TUs comprised by the partial-TU stripe.

### REFERENCE TO RELATED APPLICATION

This application claims the priority benefit of U.S. Provisional Patent Application No. 63/561,194, filed Mar. 4, 2024, the entirety of which is incorporated herein by reference.

### TECHNICAL FIELD

Embodiments of the disclosure relate generally to memory sub-systems, and more specifically, to bad-deck management for half-good blocks.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system according to embodiments.

FIG. 1B is a block diagram of a memory device in communication with a memory sub-system controller of a memory sub-system, in accordance with some embodiments.

FIG. 2 illustrates a bad-deck scheme across a memory device, according to various embodiments.

FIG. 3 illustrates a bad-deck scheme and a bad-deck bitmap for a memory device, according to various embodiments.

FIG. 4 is a flow chart of a method for bad-deck management for half-good blocks, according to various embodiments.

FIG. 5 is a block diagram of an example computer system in which embodiments of the present disclosure can operate.

### DETAILED DESCRIPTION

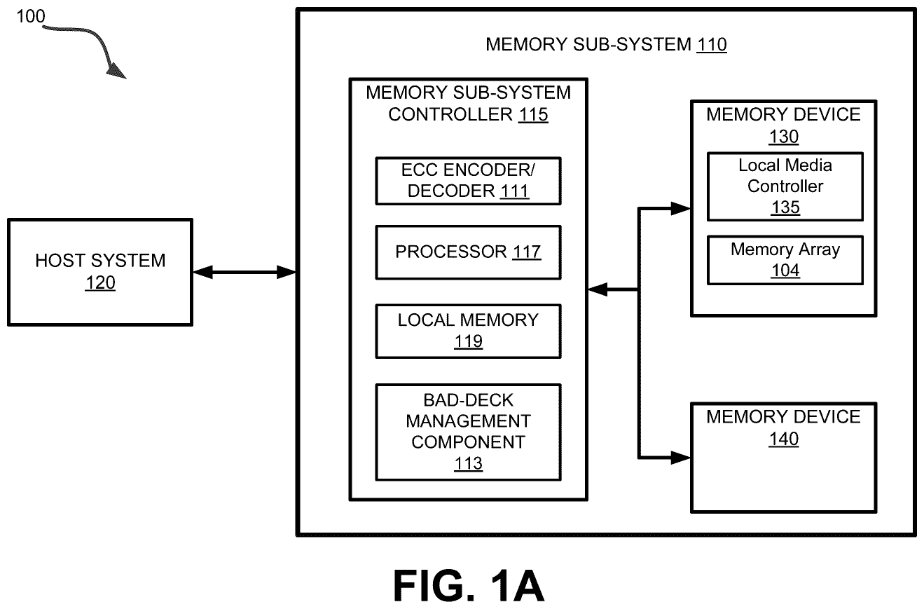

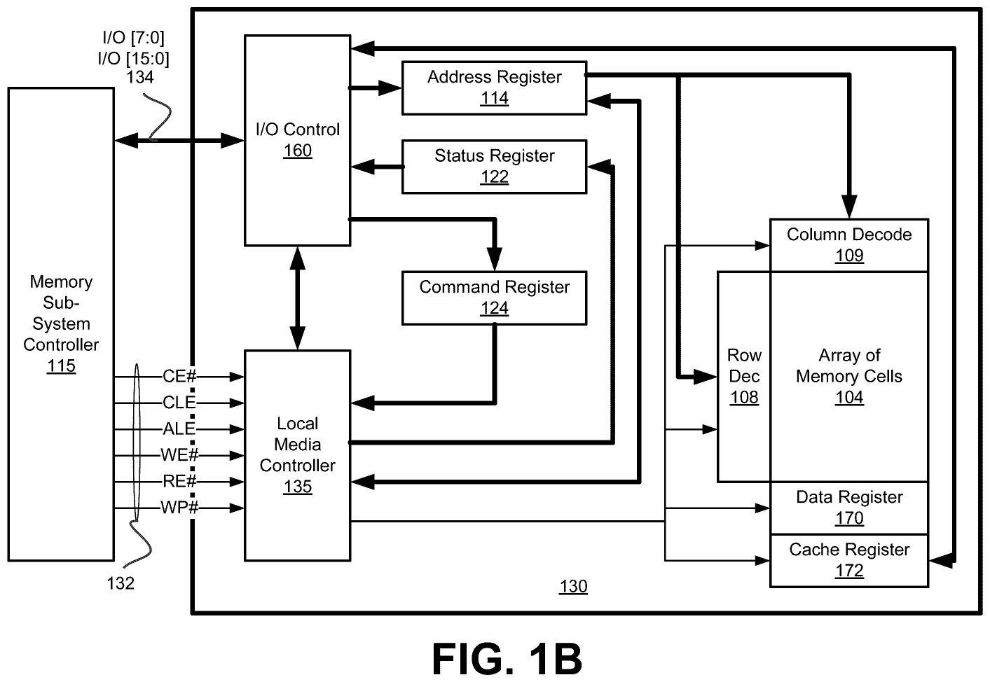

Aspects of the present disclosure are directed to bad-deck management for half-good blocks. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not- and (NAND) memory device. Other examples of non-volatile memory devices are described below in conjunction with FIG. 1. A non-volatile memory device is a package of one or more dies. Each die can include of one or more planes. Each plane carries a matrix of memory cells formed onto a silicon wafer and joined by conductors referred to as wordlines and bitlines, such that a wordline joins multiple memory cells forming a row of the matric of memory cells, while a bitline joins multiple memory cells forming a column of the matric of memory cells.

For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Within a memory sub-system, a translation unit (TU) can serve as a fundamental unit of data management. In some embodiments of the present disclosure, a TU can include a page, a block, a superblock, and/or the like. For the purposes of illustration, this discussion primarily uses ‘blocks’ as examples of TUs. However, the description outlined herein can extend beyond blocks, covering other forms of TUs such as pages, superblocks, etc. The present disclosure can be applicable across different types of TUs (e.g., pages, block, superblocks, etc.), enabling adaptation of the present disclosure to a wide range of operational scenarios and memory system architectures. A block hereinafter refers to a unit of the memory device used to store data and can include a group of memory cells, a wordline group, or a wordline. A memory array can be divided into multiple, equal-sized decks (e.g., each deck contains the same number of wordlines). A deck refers to a portion of a physical memory array that includes a subset of a memory cells of a block, such that a block can span over one or more decks, which can be separated by dummy wordlines. A deck includes multiple horizontally stacked layers. The structure of some memory devices can be formed using a deck-by-deck process, during which some of the control gates and associated memory cells and switches are formed first in a first deck, and the other control gates and associated memory cells and switches can be formed second in a second deck. The first deck can be positioned physically below the second deck. A plane can be a vertical subdivision of the memory device. The controller can access multiple planes in parallel. That is, the controller can perform concurrent access operations on multiple planes. A plane can include one or more blocks. Thus, a deck can be defined as a two-dimensional (2D) array of memory cells electronically addressable by a vertical access line(s) (e.g., wordline(s)). Multiple decks can be stacked within a memory device (e.g., stacked vertically).

As described above, a physical block can include memory cells residing, for example, on an upper deck and a lower deck. Some memory devices, such as three-dimensional (3D) cross-point devices, can include multiple portions. A portion, such as a deck, can be defined as a two-dimensional (2D) array of memory cells electronically addressable by a vertical access line(s). Multiple decks can be stacked within a memory device (e.g., stacked vertically). As such, a memory device could include a top (or “upper”) deck and a bottom (or “lower”) deck, each including a respective set of wordlines from the memory device. The separate decks are individually accessible, such that a memory access operation (i.e., a program, read, or erase operation) could be performed on one deck without impacting memory cells of the other deck. As such, the granularity of memory device becomes smaller to the granularity of deck. Some solutions for bad-block management may categorize each physical block as either entirely good or entirely bad (e.g., full-good block or full-bad block). However, in scenarios where at least one portion of a physical block (e.g., the upper deck) is bad, while at least one portion of the physical block (e.g., the lower deck) remains functional, such an approach leads to a reduced number of valid blocks in a plane.

The number of valid blocks per plane in an SSD may directly impact the overprovisioning of the SSD. One time programmable (OTP) bad blocks may impact the number of valid blocks per plane. OTP bad blocks may be identified during the manufacturing or post-manufacturing process. Compared to OTP blocks, there may be a relatively low occurrence of grown bad blocks, which develop over the course of the lifecycle of the SSD due to wear and tear or other operational factors. Categorizing a physical block as entirely bad (e.g., either during or after manufacturing) because of one bad portion of the physical block can lead to a significant decrease in the number of valid blocks. These partial-bad blocks (e.g., half-good blocks) can include good portions (e.g., decks) that go unused because the entire block is marked bad, leading to reduced overprovisioning. Reduced overprovisioning can adversely affect system performance, reduce data storage efficiency, and increase wear on the remaining valid blocks. Increasing the number of valid blocks is both technically challenging and cost-sensitive, especially as NAND layers deepen with each generation.

A physical block may be partially good (e.g., all cells of an upper deck of a physical block is good while at least one cell of a lower deck of the physical block is bad). For example, in such blocks, the upper deck might be good while the lower deck is bad, or vice versa. However, each deck within a block can be physically isolated and function independently from the others. Therefore, two physical half-good blocks in the same plane can be combined into a single virtual good block, thus effectively increasing the usable memory capacity. In some implementations, the virtual block number can be mapped to the actual physical half-good blocks through a redirection process, enabling a controller of the SSD to accurately place data in the correct half-good blocks. This combination and redirection technique may improve the utilization of memory blocks that would otherwise be wholly classified as bad, thus increasing the total number of valid blocks available for storage. This technique may be particularly vital as NAND layers become denser with each generation, posing challenges in maintaining a high count of valid blocks and ensuring sufficient system overprovisioning.

The binary system of classifying blocks either as fully good or fully bad leads to potential wastage, especially in cases where only part of the block is defective. However, some solutions for bad block management, which employ a bitmap to indicate the health status of blocks, may fall short when it comes to managing these decks at a granular level. The bitmap lacks the necessary bit-depth to accurately represent the health status of individual decks within a block, rendering it inadequate for deck-level management.

Aspects and implementations of the present disclosure address these and other deficiencies by implementing bad-deck management for bad blocks. For example, a processing device of an SSD can use a pointer to track a sequence of half-blocks arranged for use in a half-block stripe. Within each block, memory cells of the block can reside, for example, on an upper deck and a lower deck. Each deck can include multiple pages. In some embodiments, memory cells of a block can reside on any number of decks (e.g., three decks, four decks, etc.) A half-block can include portions of one or more decks and a plurality of pages. The sequence of half-blocks can span over multiple of dies of the SSD. The half-block stripe can be used in one or more write operations (e.g., on blocks that make up the half-block stripe).

The processing device can determine the health status of half-blocks to be good or bad. By determining the health status of half-blocks, it can be determined if the half-blocks will be used in the half-block stripe. For example, when the processing device determines that a health status of at least one sub-unit (e.g., an individual memory cell or a page) of a half-block is bad, the health status of the half-block is determined to be bad. Alternatively, when the processing device determines that a health status of each sub-unit (e.g., individual memory cells or pages) the half-block is good, the health status of the half-block is determined to be good. The processing device can generate a data structure (e.g., a bitmap) based on the health statuses of the half-blocks. For example, the data structure can be a bitmap. Each bit of the bitmap can indicate a health status of a corresponding half-block. For example, a 1 can indicate a healthy half-block and a 0 can indicate an unhealthy or bad half-block. Subsequently, the processing device can determine the health status of each half-block based on the bitmap.

In some embodiments, by extending a block-level bitmap to a deck-level bitmap, firmware of the memory device can determine the exact state of each deck (e.g., good or bad). For example, during a write translation, an FTL translation module of firmware of the memory device can determine the health of each deck (e.g., the upper and lower decks) forming part of a half-block stripe (e.g., deck stripe), and can skip any bad half-blocks as it begins translating data into the first page stripe of each half-block stripe (e.g., deck stripe).

When the processing device determines that a first half-block is healthy, the processing device can append the first half-block to a half-block stripe and increment the pointer to identify a second half-block. In response to determining that the second half-block is unhealthy (bad), the processing device does not add the second half-block to the half-block stripe and increments the pointer. By skipping any half-blocks that are bad only good half-blocks are included in the half-block stripe. The processing device can then perform write operations on blocks that make up the half-block stripe.

Advantages of the present disclosure include an increased number of valid blocks in a plane, leading to increased overprovisioning. By increasing overprovisioning, aspects and implementations of the present disclosure can enhance system performance, increase data storage efficiency, and decrease wear on the remaining valid blocks. Aspects and implementations of the present disclosure can decrease wastage of half-good blocks, in cases where only part of the block is defective. Aspects and implementations of the present disclosure allow for blocks to be managed at a more granular level (e.g., half-block level, deck level, etc.). Aspects and implementations of the present disclosure include the necessary bit-depth to accurately represent the health status of individual decks within a block. These and other advantages will be discussed hereinafter, as would be apparent to those skilled in the art of media management.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such. Each memory device 130 or 140 can be one or more memory component(s).

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components or devices, which can be an indirect communicative connection or direct communicative connection (e.g., without intervening components or devices), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include NOT-AND (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of MLC memory cells, such as bi-level cells (BLCs), triple-level cells (TLCs), quad-level cells (QLCs), and penta-level cells (PLCs) can store multiple bits per cell. In some embodiments, each of the memory devices 130 can include one or more arrays of memory cells such as SLCs, BLCs, TLCs, QLCs, PLCs or any combination of such. In some embodiments, a particular memory device can include an SLC portion, and an BLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), NOT-OR (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, the memory devices 130 are managed memory devices, which is a raw memory device combined with a local controller (e.g., the local media controller 135) for memory management within the same memory device package or memory die. An example of a managed memory device is a managed NAND (MNAND) device. Memory device 130, for example, can represent a single die or multiple dice having some control logic (e.g., local media controller 135) embodied thereon. In some embodiments, the memory device 130 includes the local media controller 135 and a memory array 104 coupled to the local media controller 135. In some embodiments, one or more components of the memory sub-system 110 are omitted.

In some embodiments, the controller 115 includes an error-correcting code (ECC) encoder/decoder 111. The ECC encoder/decoder 111 can perform ECC encoding for data written to the memory devices 130 and ECC decoding for data read from the memory devices 130, respectively. The ECC decoding can be performed to decode an ECC codeword to correct errors in the raw read data, and in many cases also to report the number of bit errors in the raw read data.

The memory sub-system 110 includes a bad-deck management component 113 that can implement bad-deck management for bad blocks. In some embodiments, the memory sub-system controller 115 includes at least a portion of the bad-deck management component 113. In some embodiments, the bad-deck management component 113 is part of the host system 120, an application, or an operating system. In other embodiments, local media controller 135 includes at least a portion of bad-deck management component 113 and is configured to perform the functionality described herein.

The bad-deck management component 113 can implement bad-deck management for bad blocks. For example, bad-deck management component 113 can identify half-blocks in an ordered sequence of half-blocks to be used in a half-block stripe. In some embodiments, the ordered sequence of half-blocks can refer to an arrangement of half-blocks that can be organized in a particular order for use within, for example, a half-block stripe. In some embodiments, the ordered sequence can help to manage and utilize half-blocks for data storage, helping to ensure that data is written and accessed without failures. The half-block pointer can be a reference point, identifying and keeping track of the position of each half-block of the ordered sequence. The ordered sequence of half-blocks can be determined, for example, by firmware (e.g., of memory device 130, memory device 140, memory sub-system 110, etc.) or a flash translation layer (FTL) (e.g., of memory device 130, memory device 140, memory sub-system 110, etc.).

Within each physical block, decks can be defined as distinct portions of the physical block (e.g., an upper deck of a block). A physical block can include memory cells residing, for example, on an upper deck and a lower deck. Each deck can include multiple subsets of memory cells, each subset associated with a respective TU (e.g., a page). A half-block, formed by multiple pages, can include memory cells residing on one or more decks. The ordered sequence, to be used in the half-block stripe, can span over a plurality of dies of memory device 130. Memory device 130 can contain multiple dies including many individual memory cells. Within each die, the individual memory cells can be organized into blocks. Blocks can be divided into pages, which can be the smallest writeable units of data storage. A block stripe can be a collection of blocks that are logically grouped across multiple dies within memory device 130. Memory device 130 can also include decks. Decks can be defined as a two-dimensional (2D) array of memory cells electronically addressable by a vertical access line(s) and can span multiple blocks.

The bad-deck management component 113 can determine the health status of a half-block to be good or bad by determining the health status of memory cell(s) of the half-block. The bad-deck management component 113 can generate a data structure based on the determination of the health statuses of half-blocks. The data structure can include a plurality of elements (e.g., a bitmap having a plurality of bits). Each element of the data structure can indicate a health status of a corresponding half-block. Subsequently, the bad-deck management component 113 can determine the health status of each half-block based on the data structure.

In response to determining that a first half-block has a good health status, the bad-deck management component 113 can append the first half-block to a half-block stripe. In response to determining that a second half-block has a bad health status, the bad-deck management component 113 can bypass the second half-block without appending the second half-block to the half-block stripe. This ensures that only good half-blocks and not bad half-blocks are included in the half-block stripe.

In some embodiments, the selection of half-blocks in the half-block stripe, can be performed by firmware (e.g., of memory device 130, memory device 140, memory sub-system 110, etc.). The selection of the first half-block in the half-block strip, and subsequent half-blocks (e.g., the second half-block), can be carried out by the firmware. In some embodiments, the processing device can assess the health and wear level of available half-blocks to choose half-blocks that meet reliability criteria and align with wear leveling objectives (e.g., to prolong the lifespan of memory device 130).

The bad-deck management component 113 can perform one or more write operations on blocks making up the half-block stripe. Further details with regards to the operations of the bad-deck management component 113 are described below.

The bad-deck management component 113 is responsible for handling interactions of the memory sub-system controller 115 with the memory devices of the memory sub-system 110, such as the memory device 130. For example, the bad-deck management component 113 can send memory access commands corresponding to requests received from the host system 120 to the memory device 130, such as program commands, read commands, or other commands. In addition, the bad-deck management component 113 can receive data from the memory device 130, such as data retrieved in response to a read command or a confirmation that a program command was successfully performed. In some embodiments, the memory sub-system controller 115 includes at least a portion of the bad-deck management component 113. For example, the controller 115 can include a processor 117 (e.g., a processing device) configured to execute instructions stored in the local memory 119 for performing the operations described herein. In some embodiments, the bad-deck management component 113 is part of the host system 120, an application, or an operating system.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses. In one embodiment, local media controller 135 can implement bad-deck management for bad blocks by managing memory cells in decks identified as bad within a block of memory array 104, redirecting operations away from these bad decks while optimizing the use of remaining functional decks within the same block.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer of the memory device 130. A page buffer may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 134 and outputs data to the memory sub-system controller 115 over I/O bus 134.

For example, the commands may be received over input/output (I/O) pins [7:0] of I/O bus 134 at I/O control circuitry 160 and may then be written into command register 124. The addresses may be received over input/output (I/O) pins [7:0] of I/O bus 134 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

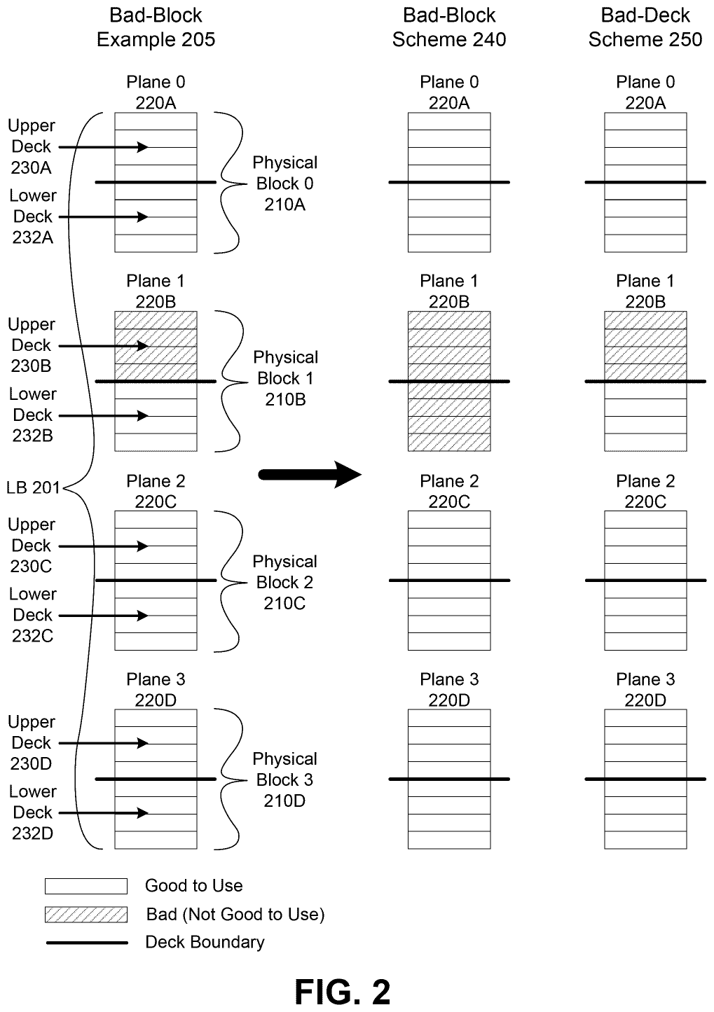

FIG. 2 illustrates a bad-deck scheme 250 across planes (e.g., planes 220A-D) of a memory device, according to various embodiments. For purposes of illustration and comparison FIG. 2 also includes a conventional bad-block scheme 240.

Logical block 201 can reference multiple physical blocks 210A-D. In this example, logical block 201 references four physical blocks 210A-D. A logical block can reference fewer or more than four physical blocks. Each physical block 410A-D can correspond to a different plane. Each physical block 210A-D can include memory cells residing, for example, on an upper deck and a lower deck. (e.g., upper decks 230A-D and lower decks 232A-D). A physical block can include more than two decks, for example, if the memory device supports more than two decks per block. In some embodiments, memory subsystem controller 115 can implement bad-deck management for half-good blocks, for example, by managing block on a deck-level rather than on a block level.

For example, bad-block example 205 includes physical blocks 210A, 210C, and 210D that include memory cells residing in an upper deck (e.g., 230A, 230C, and 230D) and a lower deck (e.g., 232A, 232C, and 232D) that are both marked ‘good to use.’ Using the conventional bad-block scheme 240 the upper decks (e.g., 230A, 230C, and 230D) and lower decks (e.g., 232A, 232C, and 232D) are marked collectively as good creating a full-good block. Using bad-deck scheme 250 the upper decks (e.g., 230A, 230C, and 230D) and lower decks (e.g., 232A, 232C, and 232D) are marked individually as good creating two half-good blocks (e.g., a full-good block). However, bad-block situation 205 includes physical block 210B that includes memory cells residing in an upper deck 230B that is marked as bad and a lower deck 232B that is marked as good to use. Under conventional bad-block scheme 240 the entire block is marked as bad (e.g., a full-bad block) because one deck (e.g., upper deck 230B) of the block is bad. However, under bad-deck scheme 250 only upper deck 230B is marked as bad and lower deck 232B is marked as good, making more decks available for use. In some embodiments, bad-deck management allows partials blocks of a block (e.g., decks) to be managed independently of other partial blocks of the block, making more partials blocks (e.g., decks) available for use. By making more decks available for use overprovisioning is increased, leading to enhanced system performance, increased data storage efficiency, and decreased wear on the remaining valid blocks.

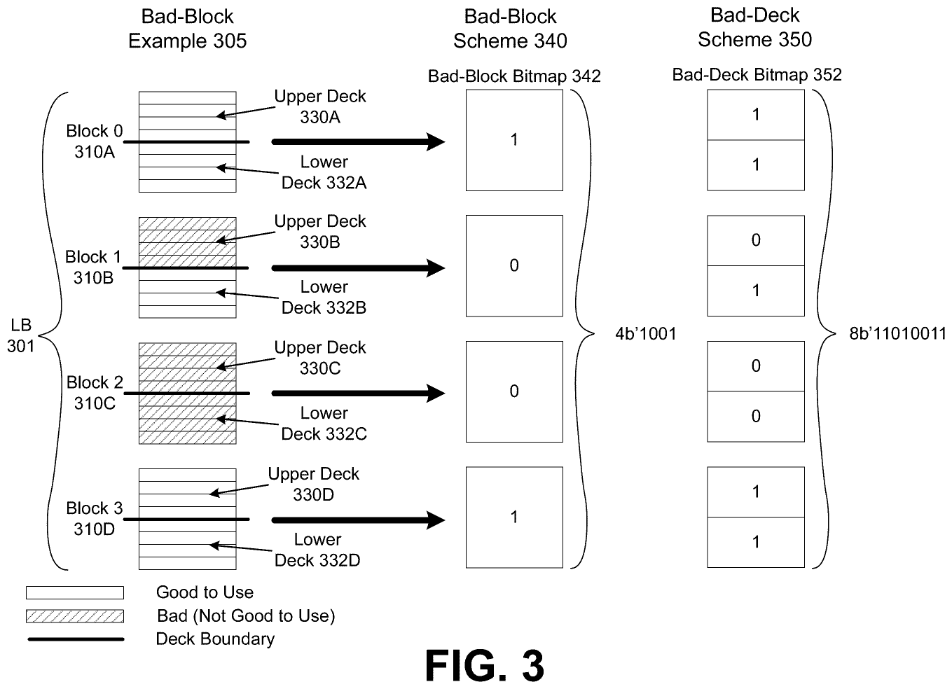

FIG. 3 illustrates a bad-deck scheme 350 and a bad-deck bitmap 352 for a memory device, according to various embodiments. For purposes of illustration and comparison FIG. 3 also includes a conventional bad-block scheme 340 and bad-block bitmap 342.

Logical block 301 can reference multiple physical blocks 210A-D. In this example, logical block 301 references four physical blocks 310A-D. Each physical block 310A-D can include memory cells residing in an upper deck and a lower deck (e.g., upper decks 330A-D and lower decks 332A-D). a physical block can include more than two decks, for example, if the memory device supports more than two decks per block. In some embodiments, memory subsystem controller 115 can implement bad-deck management for half-good blocks, for example, by generating a bad-deck bitmap 352. In some embodiments, bad-deck bitmap 352 is generated based on health statuses of decks of a block.

For example, bad-block situation 305 includes physical blocks 310A and 310D that each include memory cells residing in an upper deck (e.g., 330A and 330D, respectively) and a lower deck (e.g., 332A and 332D, respectively) that are both marked ‘good to use.’ Using the conventional bad-block scheme 340 the upper decks (e.g., 330A and 330D) and lower decks of blocks 310A and 310D (e.g., 232A, 232C, and 232D) are marked collectively as good creating a full-good block. Conventionally, a bad-block bit map 342 is generated based on bad-block scheme 340. The conventional bad-block bitmap includes only 1 bit per block. Using bad-deck scheme 350 the upper decks (e.g., 330A, 330C, and 330D) and lower decks of blocks 310A and 310D (e.g., 332A, 332C, and 332D) are marked individually as good creating two half-good blocks (e.g., a full-good block). Using bad-deck scheme 350 a bad-deck bitmap 352 is generated that includes 1 bit for each deck of a block. For example, Block 0 310A includes memory cells residing in two different decks (upper deck 330A and lower deck 332A) each being represented by a bit in bad-deck bitmap 352.

Bad-block situation 305 further includes physical block 310C that includes memory cells residing in an upper deck (e.g., 330C) and a lower deck (e.g., 332C) that is both marked as bad. Using the conventional bad-block scheme 340 upper deck 330C and lower decks 332C are marked collectively as bad creating a full-bad block. Conventionally, a bad-block bit map 342 is generated based on bad-block scheme 340. The conventional bad-block bitmap 342 includes only 1 bit per block. Using bad-deck scheme 250 the upper deck of block 310C and lower decks 332C are marked individually as bad creating two half-bad blocks (e.g., a full-bad block). Using bad-deck scheme 350 a bad-deck bitmap 352 is generated that includes 1 bit for each deck of a block. For example, Block 310C includes memory cells residing in two different decks (upper deck 330C and lower deck 332C) each being represented by a bit in bad-deck bitmap 352.

Bad-block situation 305 further includes physical block 310B that includes memory cells residing in an upper deck 330B that is bad and a lower deck 332B that is good. Under conventional bad-block scheme 340 the entire block is marked as bad (e.g., a full-bad block) because one deck (e.g., upper deck 330B) of the block is bad and one bit is generated for block 1 310B. This bit marks the entire block as bad, even though half of the block (e.g., lower deck 332B) is functional. This leads to a loss of functional half blocks. However, under bad-deck scheme 350 only upper deck 330B is marked as bad and lower deck 332B is marked as good, making more decks available for use. This is reflected in bad-deck bitmap 352, where each deck (e.g., upper deck 330B and lower deck 332B) corresponds to a separate bit of bad-deck bitmap 352. In some embodiments, bad-deck management allows for a more granular bitmap (e.g., bad-deck bitmap 352) where portions of a block (e.g., decks) are represented by separate bits independent of other portions of the block. Use of bad-deck bitmap 352 allows for mapping of more portions of the block (e.g., decks) as available for use. By mapping more decks as available for use overprovisioning is increased, leading to enhanced system performance, increased data storage efficiency, and decreased wear on the remaining valid blocks.

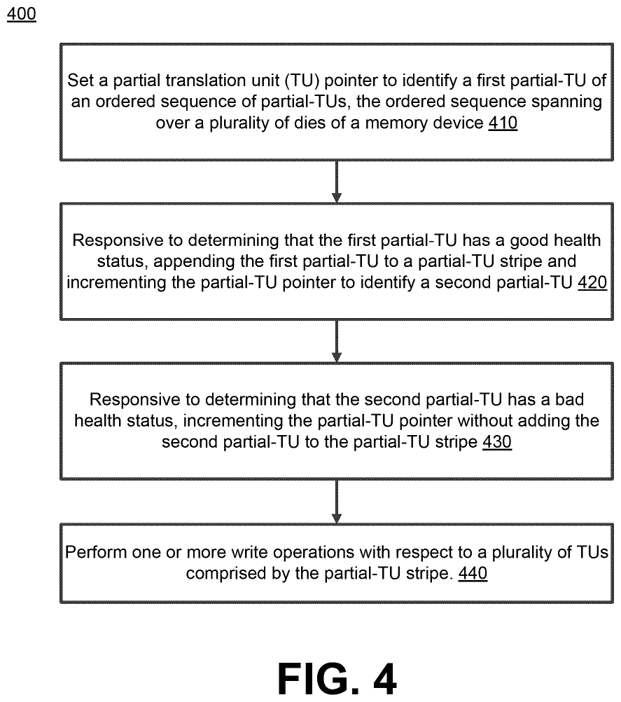

FIG. 4 is a flow chart of a method 400 for bad-deck management for bad blocks, according to various embodiments. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the controller 115 (e.g., bad-deck management component 113) and/or the local media controller 135 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic sets a partial translation unit (TU) pointer to identify a first partial-TU of an ordered sequence of partial-TUs. In some embodiments, the ordered sequence spans over a plurality of dies of a memory device. In some embodiments, a TU can be a block and a partial-TU can be a half-block (e.g., a portion of a block).

At operation 420, processing logic responsive to determining that the first partial-TU has a good health status, appends the first partial-TU to a partial-TU stripe and increments the partial-TU pointer to identify a second partial-TU. In some embodiments, the first partial-TU includes a plurality of translation sub-units (TSUs). In some embodiments, the health status of the first partial-TU is determined to be good in response to determining a health status of each TSU of the plurality of TSUs of the first partial-TU is determined to be good.

At operation 430, the processing logic responsive to determining that the second partial-TU has a bad health status, increments the partial-TU pointer without adding the second partial-TU to the partial-TU stripe. For example, when the processing logic determines the second partial-TU (e.g., second half-block, second deck, etc.) is a bad partial-TU within the partial-TU stripe, the processing logic can skip or bypasses this bad partial-TU. The bad partial-TU is thus excluded from data storage and retrieval processes. In some embodiments, the second partial-TU can include a plurality of TSU (e.g., pages, memory cells etc.). In some embodiments, the health status of the second partial-TU is determined to be bad in response to determining that a health status of at least one TSU of the plurality of TSUs of the second partial-TU is bad.

In some embodiments, the processing logic of method 400 can further generate a data structure including a plurality of elements. In some embodiments, an element of the data structure indicates a health status of a corresponding partial-TU. In some embodiments, the generating the data structure is done in at least one of a pre-runtime state or a runtime state of the memory device. For example, OTP partial-bad blocks (e.g., bad partial-TUs) are typically determined during the manufacturing process (e.g., a pre-runtime state of the memory device). However, in some embodiments, the generating the data structure can be done during a run-time state of the memory device (e.g., to determine GBBs). In some embodiments, the data structure can be generated in a pre-runtime state and be updated in a run-time state (e.g., updated based on GBBs during run-time). In some embodiments, the data structure can be stored in a slow memory (e.g., SRAM) of the memory device.

In some embodiments, in order to implement the deck-level bitmap, the memory device system can provide any extra memory necessary. In some embodiments, the deck-level bit map may not require fast memory (e.g., static random-access memory (SRAM)) to store the bitmap. In some embodiments, the deck-level bitmap may be access so infrequently as to not require storage in fast memory.

In some embodiments, the system may have fast memory (e.g., SRAM or data cache coherent memory (DCCM)) and slow memory (e.g., DRAM). The deck-level bitmap can be accessed once each time a new block stripe is initialized. A block stripe in an SSD can be relatively large, leading to a longer time required to fully utilize the capacity of the block stripe. The process of fully utilizing the block stripe can take about 100 milliseconds or even up to one second. As a result, the system accesses the slower memory, which contains information about the block stripe, less frequently, typically at intervals ranging from every 100 milliseconds to every second. A single block stripe in an SSD can include of many pages (e.g., 1000 pages). For every page stripe within the block stripe, the firmware of the system can verify the bit information specific to the block stripe. In the cache architecture the bitmap can be stored in SRAM. When programming begins for a new stripe, the bitmap is accessed from the SRAM to obtain the bit information for the specific block stripe (e.g., the new block stripe). This information is then transferred to DCCM, facilitating the process of checking the bit information for each page stripe within the block stripe.

In some embodiments, the processing logic of method 400 can further update physical to logical (P2L) address mappings of a P2L table of the memory device in response to incrementing the partial-TU pointer without adding a partial-TU to the partial-TU stripe.

In some embodiments, the determining the health status of the first partial-TU and the health status of the second partial-TU can be based on the data structure including a plurality of elements (e.g., the generated data structure). In some embodiments, an element of the data structure indicates a health status of a corresponding partial-TU.

At operation 440, the processing logic performs one or more write operations with respect to a plurality of TUs comprised by the partial-TU stripe. In some embodiments, the processing logic of method 400 can further performing one or more read operations on the plurality of TUs making up the partial-TU stripe.

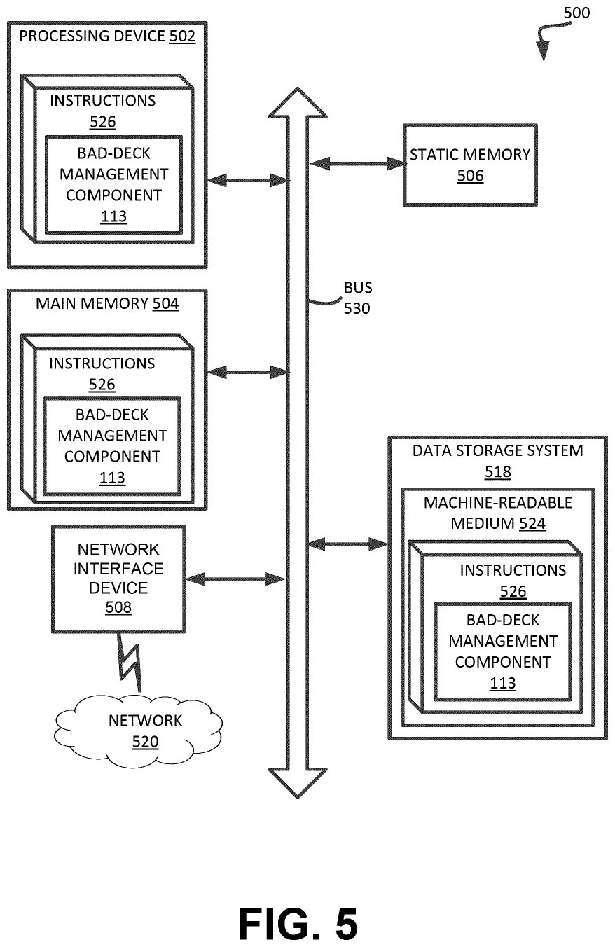

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIGS. 1A-1B.

In one embodiment, the instructions 526 include instructions to implement functionality corresponding to bad-deck management component 113 of FIG. 1A. While the machine-readable storage medium 524 is shown in an example embodiment to be a single medium, the term “non-transitory computer-readable storage medium” should be taken to include a single medium or multiple media that store the one or more sets of instructions. The term “machine-readable storage medium” or “computer-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device operatively coupled to the memory device, the processing device to perform operations comprising:
setting a partial translation unit (TU) pointer to identify a first partial-TU of an ordered sequence of partial-TUs, the ordered sequence spanning over a plurality of dies of the memory device;
responsive to determining that the first partial-TU has a good health status, appending the first partial-TU to a partial-TU stripe and incrementing the partial-TU pointer to identify a second partial-TU;
responsive to determining that the second partial-TU has a bad health status, incrementing the partial-TU pointer without adding the second partial-TU to the partial-TU stripe; and
performing one or more write operations on a plurality of TUs comprised by the partial-TU stripe.

2. The system of claim 1, wherein the second partial-TU comprises a plurality of translation sub-units (TSUs), and wherein the health status of the second partial-TU is determined to be bad in response to determining that a health status of at least one TSU of the plurality of TSUs of the second partial-TU is bad.

3. The system of claim 1, wherein the first partial-TU comprises a plurality of TSUs, and wherein the health status of the first partial-TU is determined to be good in response to determining a health status of each TSU of the plurality of TSUs of the first partial-TU is determined to be good.

4. The system of claim 1, wherein the operations further comprise updating physical to logical (P2L) address mappings of a P2L table of the memory device in response to incrementing the partial-TU pointer without adding a partial-TU to the partial-TU stripe.

5. The system of claim 1, wherein the determining the health status of the first partial-TU and the health status of the second partial-TU is based on a data structure comprising a plurality of elements, wherein an element of the data structure indicates a health status of a corresponding partial-TU.

6. The system of claim 1, wherein the operations further comprise generating a data structure comprising a plurality of elements, wherein an element of the data structure indicates a health status of a corresponding partial-TU.

7. The system of claim 6, wherein the generating the data structure is done in at least one of a pre-runtime state or a runtime state of the memory device.

8. The system of claim 1, wherein the operations further comprise performing one or more read operations on the plurality of TUs comprised by the partial-TU stripe.

9. The system of claim 1, wherein the partial-TU stripe is a half-block stripe.

10. A method comprising:
setting, by a processing device, a partial translation unit (TU) pointer to identify a first partial-TU of an ordered sequence of partial-TUs, the ordered sequence spanning over a plurality of dies of a memory device;
responsive to determining that the first partial-TU has a good health status, appending the first partial-TU to a partial-TU stripe and incrementing the partial-TU pointer to identify a second partial-TU;
responsive to determining that the second partial-TU has a bad health status, incrementing the partial-TU pointer without adding the second partial-TU to the partial-TU stripe; and
performing one or more write operations with respect to a plurality of TUs comprised by the partial-TU stripe.

11. The method of claim 10, wherein the second partial-TU comprises a plurality of translation sub-units (TSUs), and wherein the health status of the second partial-TU is determined to be bad in response to determining that a health status of at least one TSU of the plurality of TSUs of the second partial-TU is bad.

12. The method of claim 10, wherein the first partial-TU comprises a plurality of TSUs, and wherein the health status of the first partial-TU is determined to be good in response to determining that a health status of each TSU of the plurality of TSUs of the first partial-TU is determined to be good.

13. The method of claim 10, wherein the determining the health status of the first partial-TU and the health status of the second partial-TU is based on a data structure comprising a plurality of elements, wherein an element of the data structure indicates a health status of a corresponding partial-TU.

14. The method of claim 10, further comprising generating a data structure comprising a plurality of elements, wherein an element of the data structure indicates a health status of a corresponding partial-TU.

15. The method of claim 14, wherein the generating the data structure is done in at least one of a pre-runtime state or a runtime state of the memory device.

16. A non-transitory computer-readable storage medium storing instructions, which when executed by a processing device, cause the processing device to perform operations comprising:
setting a partial translation unit (TU) pointer to identify a first partial-TU of an ordered sequence of partial-TUs, the ordered sequence spanning over a plurality of dies of a memory device;
responsive to determining that the first partial-TU has a good health status, appending the first partial-TU to a partial-TU stripe and incrementing the partial-TU pointer to identify a second partial-TU;
responsive to determining that the second partial-TU has a bad health status, incrementing the partial-TU pointer without adding the second partial-TU to the partial-TU stripe; and
performing one or more write operations with respect to a plurality of TUs comprised by the partial-TU stripe.

17. The non-transitory computer-readable storage medium of claim 16, wherein the determining the health status of the first partial-TU and the health status of the second partial-TU is based on a data structure comprising a plurality of elements, wherein an element of the data structure indicates a health status of a corresponding partial-TU.

18. The non-transitory computer-readable storage medium of claim 16, wherein the operations further comprise generating a data structure comprising a plurality of elements, wherein an element of the data structure indicates a health status of a corresponding partial-TU.

19. The non-transitory computer-readable storage medium of claim 18, wherein the generating the data structure is done in at least one of a pre-runtime state or a runtime state of the memory device.

20. The non-transitory computer-readable storage medium of claim 16, wherein the partial-TU stripe is a half-block stripe.
